(19) United States
(12) Patent Application Publication
(10) Pub. No.: US 2026/0365765 A1
(43) Pub. Date: Nov. 19, 2026

(54) FERROELECTRIC POLYMER

(71) Applicant: ARKEMA FRANCE, Puteaux (FR)

(72) Inventors: Thierry LANNUZEL, Pierre-Benite Cedex (FR); Fabrice DOMINGUES DOS SANTOS, Puteaux (FR)

(73) Assignee: ARKEMA FRANCE, Puteaux (FR)

(21) Appl. No.: 19/144,106

(22) PCT Filed: Dec. 22, 2023
(86) PCT No.: PCT/EP2023/087572

§ 371 Date: Jun. 27, 2025

(30) Foreign Application Priority Data
Dec. 29, 2022 (FR) FR2214661

(51) Int. Cl. C08F 14/24; C08F 14/22

(52) U.S. Cl. CPC C08F 14/24; C08F 14/22

(57) ABSTRACT

The invention relates to a polymer essentially consisting of, or consisting of, repeating units derived from vinylidene fluoride (VDF), trifluoroethylene (TrFE), and at least one third monomer different from vinylidene fluoride and trifluoroethylene, the molar ratio TrFE:VDF between the number of moles in the unit derived from trifluoroethylene and that in the unit derived from vinylidene fluoride in the polymer being 14.0:86.0 to 50.0:50.0, the at least one third monomer having a mole fraction xt greater than or equal to 1 ppm and less than or equal to 5000 ppm relative to the total number of moles in the units derived from VDF and TrFE in the polymer.

### TECHNICAL FIELD

The invention relates to the field of ferroelectric polymers.

The invention relates more particularly to copolymers, in the broad sense, comprising repeating units derived from vinylidene fluoride and trifluoroethylene.

### PRIOR ART

The copolymer consisting of repeating units derived from vinylidene fluoride and trifluoroethylene, poly(VDF-co-TrFE), also denoted P(VDF-TrFE), is a polymer known for its ferroelectric properties. It is characterized especially by a broad hysteresis cycle of the electrical polarization curve as a function of the electric field applied.

The application to the P(VDF-TrFE) of an electric field at a value greater than a characteristic field called coercive field (E_{c}) makes it possible to orient dipoles formed by the C—F bonds in the same direction, in a sufficiently stable manner, so as to obtain a remanent polarization (Pᵣ) with zero electric field.

There is currently a need to provide ferroelectric polymers having a higher remanent polarization, in order to be able especially to increase the sensitivity of electronic devices, for example a sensor or a memory, which incorporate these materials.

Moreover, when a ferroelectric material has a high coercive field, it is then necessary to apply high voltages to it in order to be able to polarize it, which leads to an overconsumption of energy and/or to an increased risk of electrical breakdown, and/or makes it necessary to reduce the thickness of the layer of ferroelectric material. It is therefore advantageous to be able to maintain a sufficiently low coercive field.

Finally, another known measure is to introduce a few percent, typically 2% to 20%, for example about 6% to 8%, of repeating units derived from a third monomer, especially chlorotrifluoroethylene or a chlorofluoroethylene, into the crystalline structure of P(VDF-TrFE), to reduce the size of the polar domains so as to transform the copolymer with ferroelectric properties into a terpolymer with properties of a “relaxor ferroelectric”. Relaxor ferroelectric polymers are characterized especially by a hysteresis cycle of the electrical polarization curve as a function of the electric field applied that is much finer than the hysteresis cycle of ferroelectric polymers: as a result, they have a considerably lower coercive field but also a lower remanent polarization than ferroelectric polymers.

### OBJECTS OF THE INVENTION

The object of the invention is to provide a polymer having advantageous ferroelectric properties, especially ferroelectric properties that are comparable or improved with respect to P(VDF-TrFE).

An object of the invention, according to at least some embodiments, is to provide a polymer having a high remanent polarization, especially a remanent polarization comparable to or higher than P(VDF-TrFE).

An object of the invention, according to at least some embodiments, is to provide a polymer having a sufficiently low coercive field, especially a coercive field of the same order as or lower than P(VDF-TrFE).

An object of the invention, according to at least some embodiments, is to provide a polymer having a lower coercive field and a higher remanent polarization than P(VDF-TrFE).

Another object of the invention, according to at least some embodiments, is to provide a less expensive manufacturing process than that of the manufacture of P(VDF-TrFE), in order to obtain a polymer having at least ferroelectric properties comparable to those of P(VDF-TrFE).

Another object of the invention is to be able to provide electronic devices which incorporate these materials, especially in the form of films.

### SUMMARY OF THE INVENTION

The invention relates to a polymer consisting essentially of, or consisting of, repeating units derived from vinylidene fluoride (VDF), trifluoroethylene (TrFE) and at least one third monomer other than vinylidene fluoride and trifluoroethylene, having the chemical formula:

CX₁X₂═CX₃Z (I)
in which each of X₁, X₂ and X₃ is independently chosen from H, F and alkyl groups comprising from 1 to 3 carbon atoms which are optionally partially or totally fluorinated, and in which Z is chosen from Cl, Br and I,
the molar ratio TrFE:VDF between the number of moles of unit derived from trifluoroethylene and that of unit derived from vinylidene fluoride in the polymer being from 14.0:86.0 to 50.0:50.0,
said repeating unit derived from said at least one third monomer having a molar fraction xₜ of greater than or equal to 1 ppm and less than or equal to 5000 ppm, relative to the total number of moles of units derived from VDF and TrFE in the polymer.

Bearing in mind that the addition of a few percent of a third monomer, such as chlorotrifluoroethylene, or a chlorofluoroethylene, or else a chlorodifluoroethylene, to P(VDF-TrFE) converts the polymer having ferroelectric properties to a polymer having relaxor ferroelectric properties, having a lower crystallinity and a lower remanent polarization than P(VDF-TrFE), a person skilled in the art would have expected the introduction of the third monomer to the P(VDF-TrFE), at a molar fraction of 1 ppm to 5000 ppm, to lead also to a decrease in ferroelectric performance, especially a decrease in the remanent polarization of the polymer.

On the contrary, the inventors have discovered, surprisingly, that the presence of the third monomer at a molar fraction of 1 ppm to 5000 ppm in the polymer makes it possible at least to preserve, or even preferentially to improve, the ferroelectric performance of the polymer.

More precisely, the inventors have discovered that a content of 1 ppm to 5000 ppm of third monomer in the polymer makes it possible to maintain, and preferably to increase, the remanent polarization of the polymer.

Moreover, the inventors have discovered that a content of 1 ppm to 5000 ppm of third monomer in the polymer makes it possible to maintain, and preferably to reduce, the coercive field of the polymer.

According to some embodiments, Z in the chemical formula (I) is Cl.

According to some embodiments, each of X₁, X₂, X₃ in the chemical formula (I) is independently chosen from H and F.

According to some embodiments, said at least one third monomer comprises at least one monomer selected from the group consisting of: chlorotrifluoroethylene (CTFE), chlorodifluoroethylene, especially 1-chloro-2,2-difluoroethylene (CDFE), chlorofluoroethylene, especially 1,1-chlorofluoroethylene (CFE), and a mixture thereof.

According to some embodiments, the polymer according to the invention comprises a single third monomer selected from the group consisting of: chlorotrifluoroethylene (CTFE), chlorodifluoroethylene, especially 1-chloro-2,2-difluoroethylene (CDFE), and chlorofluoroethylene, especially 1,1-chlorofluoroethylene (CFE).

According to some embodiments, said at least one third monomer is chlorotrifluoroethylene (CTFE).

According to some embodiments, xₜ≥5 ppm, preferably xₜ≥10 ppm, and more preferably xₜ≥20 ppm.

According to some embodiments, xₜ≥400 ppm.

According to some embodiments, xₜ≥600 ppm.

According to some embodiments, xₜ≤4000 ppm, preferably xₜ≤3000 ppm, and more preferably xₜ≤2500 ppm.

According to some embodiments, xₜ≤1000 ppm.

According to some embodiments, the TrFE:VDF molar ratio in the polymer is from 15.0:85.0 to 40.0:60.0, or from 16.0:84.0 to 35.0:65.0, or from 17.5:82.5 to 27.5:72.5.

According to some embodiments, the polymer has a melt index at 230 °C under a load of 10 kg, as measured according to the standard ASTM D1238-10, of 0.1 g/10 min to 100 g/10 min. preferably of 0.5 g/10 min to 50 g/10 min and more preferably of 1 g/10 min to 10 g/10 min.

According to some embodiments, the TrFE:VDF molar ratio in the polymer is from 17.5:82.5 to 22.5:77.5, and
preferably 10 ppm≤xₜ≤3000 ppm, more preferably
200 ppm≤xₜ≤2500 ppm, and more preferably 400 ppm≤xₜ≤2000 ppm.

According to some embodiments, the TrFE:VDF molar ratio in the polymer is from 20.1:79.9 to 20.9:79.1, and
preferably 10 ppm≤xₜ≤3000 ppm, more preferably 200 ppm≤xₜ≤2500 ppm, and more preferably 400 ppm≤xₜ≤2000 ppm.

According to some embodiments, the polymer of any one of the preceding claims is obtained by a suspension polymerization process, preferably in water.

The invention also relates to a film comprising essentially or consisting of the polymer according to the invention.

In addition, the invention relates to the use of a third monomer having the chemical formula:

CX₁X₂═CX₃Z (I)
in which each of X₁, X₂ and X₃ is independently chosen from H, F and alkyl groups comprising from 1 to 3 carbon atoms which are optionally partially or totally fluorinated, and in which Z is chosen from Cl, Br and I,
as a termonomer in the structure of a polymer consisting essentially of repeating units derived from vinylidene fluoride (VDF) and trifluoroethylene (TrFE) in a molar proportion xₜ of 1 ppm to 5000 ppm with respect to the total number of moles of units derived from VDF and TrFE in the polymer,
the molar ratio TrFE:VDF in the polymer between the unit derived from TrFE and that derived from VDF being from 14.0:86.0 to 50.0:50.0,
to increase the remanent polarization thereof. The remanent polarization may especially be increased by 1% or more, or 2.0% or more, or 3.0% or more, or 4.0% or more, or 5.0% or more, or 7.5% or more, or 10.0% or more, or 11.0% or more, or 12.0% or more, with respect to the remanent polarization of P(VDF-TrFE) having an equal proportion of TrFE:VDF.

In addition, the invention relates to the use of a third monomer having the chemical formula:

CX₁X₂═CX₃Z (I)
in which each of X₁, X₂ and X₃ is independently chosen from H, F and alkyl groups comprising from 1 to 3 carbon atoms which are optionally partially or totally fluorinated, and in which Z is chosen from Cl, Br and I,
as a termonomer in the structure of a polymer consisting essentially of repeating units derived from vinylidene fluoride (VDF) and trifluoroethylene (TrFE) in a molar proportion xₜ of 1 ppm to 5000 ppm with respect to the total number of moles of units derived from VDF and TrFE in the polymer,
the molar ratio TrFE:VDF in the polymer between the unit derived from TrFE and that derived from VDF being from 14.0:86.0 to 50.0:50.0, to reduce the coercive field thereof. The coercive field may especially be reduced by 1.0% or more, or 2.0% or more, or 3.0% or more, or 4.0% or more, or 5.0% or more, relative to the coercive field of P(VDF-TrFE) having an equal proportion of TrFE:VDF.

According to advantageous embodiments, the invention relates to the use of a third monomer having the chemical formula:

CX₁X₂═CX₃Z (I)
in which each of X₁, X₂ and X₃ is independently chosen from H, F and alkyl groups comprising from 1 to 3 carbon atoms which are optionally partially or totally fluorinated, and in which Z is chosen from Cl, Br and I,
as a termonomer in the structure of a polymer consisting essentially of repeating units derived from vinylidene fluoride (VDF) and trifluoroethylene (TrFE) in a molar proportion xₜ of 1 ppm to 5000 ppm with respect to the total number of moles of units derived from VDF and TrFE in the polymer,
the molar ratio TrFE:VDF in the polymer between the unit derived from TrFE and that derived from VDF being from 14.0:86.0 to 50.0:50.0, to increase the remanent polarization thereof and to reduce the coercive field thereof.

In the abovementioned uses, according to some embodiments, it is possible to have xₜ≥25 ppm.

In the abovementioned uses, according to some embodiments, it is possible to have xₜ≤2500 ppm, or else xₜ≤800 ppm.

The invention also relates to the use of trifluoroethylene obtained by hydrogenolysis of chlorotrifluoroethylene in a process for manufacturing a polymer according to the invention, said at least one third monomer comprising chlorotrifluoroethylene, and said manufacturing process comprising a polymerization reaction step between vinylidene fluoride (VDF), trifluoroethylene (TrFE) and chlorotrifluoroethylene (CTFE).

According to advantageous embodiments of this use, the trifluoroethylene obtained by hydrogenolysis of chlorotrifluoroethylene comprises from 2 ppm to 5000 ppm or from 5 ppm to 4000 ppm, or from 20 ppm to 3000 ppm, or from 50 ppm to 2500 ppm, or from 75 ppm to 1500 ppm of chlorotrifluoroethylene per mole of trifluoroethylene.

According to some embodiments, the trifluoroethylene obtained by hydrogenolysis of chlorotrifluoroethylene comprises from 1500 ppm to 4500 ppm of chlorotrifluoroethylene per mole of trifluoroethylene.

### DETAILED DESCRIPTION OF THE INVENTION

### List of the Figures

FIG. 1 shows in superimposed form the following curves: polarization (mC/m²) as a function of the electric field applied (V/μm), for comparative example #1 (mark: “▪”) and for example 6 (mark: “▴”).

FIG. 2 shows the remanent polarization Pr (mC/m²) as a function of the proportion xₜ of CTFE for experimental results #1 to #15. Different marks have been used to differentiate samples with a molar proportion of TrFE/(VDF+TrFE) of about 20% (mark “▪”), about 25% (mark “▴”) and about 30% (mark “•”).

### DEFINITIONS

The term “copolymer” is understood to denote, in the broad sense, a polymer resulting from the copolymerization of at least two types of chemically different monomers, called comonomers. A copolymer, in the broad sense, comprises at least two types of repeating units, the (at least two) types being determined by different chemical formulae. It may for example be formed of two, three or four types of repeating units. A copolymer, in the strict sense, is formed of exactly two types of repeating units, such as, for example, P(VDF-TrFE).

The term “terpolymer” is understood to denote, in the broad sense, a polymer resulting from the copolymerization of at least three types of chemically different monomers. A terpolymer, in the strict sense, is formed of exactly three types of repeating units, such as, for example, P(VDF-TrFE-CTFE).

The term “polymer essentially consisting of repeating units” is understood to indicate that the polymer comprises at least 99 mol %, or at least 99.5 mol %, or at least 99.9 mol % of these units relative to the total number of moles of the units constituting the polymer.

The term “polymer consisting of repeating units” is understood to indicate that the polymer comprises more than 99.9 mol %, especially 100 mol %, of these units relative to the total number of moles of the units constituting the polymer.

In all of the ranges set out, the endpoints are included, unless stated otherwise.

The term “unit derived from a monomer” denotes the repeating unit deriving directly from this monomer by polymerization. For example, the unit derived from chlorotrifluoroethylene: C(F)(Cl)═CF₂ is: —C(F)(Cl)—CF₂—. The unit derived from trifluoroethylene: C(F)(H)═CF₂ is: —C(F)(H)—CF₂—, etc.

The term “about a numerical value” is understood to mean this numerical value plus or minus 5%.

The term “Curie temperature” is understood to mean the temperature at which a ferroelectric to paraelectric crystalline structure transition, called Curie transition, takes place. The Curie temperature of a ferroelectric polymer thus defines a maximum operating temperature beyond which the polymer loses its ferroelectric properties, unless a new low-temperature polarization is performed. It may be determined, for example by differential scanning calorimetry (DSC), as the temperature of the maximum of the endotherm corresponding to this transition, during the first or second heating, preferably during the second heating, at 10 °C/min, or by dielectric spectroscopy, as the temperature corresponding to the maximum of the dielectric permittivity peak during heating at 10 °C/min at a frequency of 1 kHz.

The term “melting temperature” is understood to mean the temperature at which the crystalline structure changes from a solid state to a liquid state. It can be determined, for example by differential scanning calorimetry (DSC), as the temperature of the maximum of the endotherm corresponding to this transition, during the first or second heating, preferably during the second heating, at 10 °C/min.

### Terpolymer According to the Invention

The polymer according to the invention essentially consists of, or consists of, repeating units derived from vinylidene fluoride (VDF), trifluoroethylene (TrFE) and at least one third monomer, different from vinylidene fluoride and trifluoroethylene.

The chemical formula of the third monomer is:

CX₁X₂═CX₃Z (I)
in which each of the X₁, X₂ and X₃ is independently chosen from H, F and alkyl groups comprising from 1 to 3 carbon atoms which are optionally partially or totally fluorinated, and in which Z is chosen from Cl, Br and I.

The polymer may comprise just one or two or more different third monomers. According to some embodiments, the polymer comprises two or more different third monomers. The polymer may especially comprise CTFE and at least one other third monomer, the CTFE representing at least 50 mol % relative to the total number of moles of third monomers. The CTFE may in particular represent at least 60 mol %, or at least 70 mol %, or at least 80 mol %, or at least 90 mol % relative to the total number of moles of third monomers.

According to some embodiments, Z in the chemical formula (I) is Cl.

According to some embodiments, each of X₁, X₂, X₃ in the chemical formula (I) is independently chosen from H and F.

According to some embodiments, Z in the chemical formula (I) is Cl and each of X₁, X₂ and X₃ in the chemical formula (I) is independently chosen from H and F. The third monomer, or where appropriate one of the third monomers, may be selected from the group consisting of: chlorotrifluoroethylene (CTFE), 1,1-chlorofluoroethylene (CFE) and 1-chloro-2,2-difluoroethylene (CDFE).

According to some embodiments, said at least one third monomer may be: chlorotrifluoroethylene (CTFE), 1,1-chlorofluoroethylene (CFE), 1-chloro-2,2-difluoroethylene (CDFE), or a mixture thereof.

According to some embodiments, the third monomer may be: chlorotrifluoroethylene (CTFE) or 1,1-chlorofluoroethylene (CFE).

According to particular embodiments, the third monomer may be: 1,1-chlorofluoroethylene (CFE). Thus, the polymer according to the invention may be a terpolymer essentially consisting of, or consisting of, repeating units derived from VDF, TrFE and CFE.

According to particular embodiments, as illustrated in the examples, the third monomer may be: chlorotrifluoroethylene (CTFE). Thus, the polymer according to the invention may be a terpolymer essentially consisting of, or consisting of, repeating units derived from VDF, TrFE and CTFE. In these embodiments, the CTFE can be provided at least in part by TrFE obtained by hydrogenolysis of CTFE and purified so as to retain a small amount of CTFE, as detailed later on below. Thus even in embodiments where the polymer according to the invention has ferroelectric properties comparable to those of P(VDF-TrFE), especially for a high value of xₜ, its manufacturing process has a lower cost of production than that of manufacturing P(VDF-TrFE) using a TrFE which is extremely pure and expensive to produce.

The polymer according to the invention has a molar proportion of unit derived from trifluoroethylene relative to the unit derived from vinylidene fluoride of 14.0:86.0 to 50.0:50.0. This molar proportion can especially be determined by proton NMR on the polymer.

According to some embodiments, the TrFE:VDF molar proportion of unit derived from trifluoroethylene relative to the unit derived from vinylidene fluoride in the polymer is from 50.0:50.0 to 40.0:60.0, or from 40.0:60.0 to 32.5:67.5, or from 32.5:67.5 to 27.5:72.5, or from 27.5:72.5 to 22.5:77.5, or from 22.5:77.5 to 21.5:78.5, or from 21.5:78.5 to 21.0:79.0, or from 21.0:79.0 to 20.5:79.5, or from 20.5:79.5 to 20.0:80.0, or from 20.0:80.0 to 19.5:80.5, or from 19.5:80.5 to 19.0:81.0, or from 19.0:81.0 to 18.5:81.5, or from 18.5:81.5 to 18.0:82.0, or from 18.0:82.0 to 17.5:82.5, or from 17.5:82.5 to 17.0:83.0, or from 17.0:83.0 to 16.0:84.0, or from 16.0:84.0 to 15.0:85.0, or from 15.0:85.0 to 14.0:86.0.

According to advantageous embodiments, the molar proportion of unit derived from trifluoroethylene relative to the unit derived from vinylidene fluoride in the polymer is from 17.5:82.5 to 27.5:72.5.

According to extremely advantageous embodiments, the molar proportion of unit derived from trifluoroethylene relative to the unit derived from vinylidene fluoride in the polymer is from 21.5:78.5 to 18.5:81.5. Indeed, it is known for P(VDF-TrFE) that the remanent polarization increases when the proportion of TrFE decreases and that the polymer loses its ferroelectric properties at a TrFE:VDF molar proportion of about 14.0:86.0. In addition, for a TrFE:VDF molar proportion in the polymer of 21.5:78.5 to 18.5:81.5, the Curie temperature is sufficiently distant from the melting temperature of the polymer and therefore allows easier annealing between these two temperatures, as explained later on below.

The molar proportion of unit derived from trifluoroethylene relative to the unit derived from vinylidene fluoride may especially be from 21.5:78.5 to 21.4:78.6, or from 21.4:78.6 to 21.3:78.7, or from 21.3:78.7 to 21.2:78.8, or from 21.2:78.8 to 21.1:78.9, or from 21.1:78.9 to 21.0:79.0, or from 21.0:79.0 to 20.9:79.1, or 20.9:79.1 to 20.8:79.2, or from 20.8:79.2 to 20.7:79.3, or from 20.7:79.3 to 20.6:79.4, or from 20.6:79.4 to 20.5:79.5, or from 20.5:79.5 to 20.4:79.6, or from 20.4:79.6 to 20.3:79.7, or from 20.3:79.7 to 20.2:79.8, or from 20.2:79.8 to 20.1:79.9, or from 20.1:79.9 to 20:80, or from 20:80 to 19.9:80.1, or from 19.9:80.1 to 19.8:80.2, or from 19.8:80.2 to 19.7:80.3, or from 19.7:80.3 to 19.6:80.4, or from 19.6:80.4 to 19.5:80.5 or from 19.5:80.5 to 19.4:80.6, or from 19.5:80.5 to 19.4:80.6, or from 19.4:80.6 to 19.3:80.7, or from 19.3:80.7 to 19.2:80.8, or from 19.2:80.8 to 19.1:80.9, or from 19.1:80.9 to 19.0:81.0, or from 19.0:81.0 to 18.9:81.1, or from 18.9:81.1 to 18.8:81.2, or from 18.8:81.2 to 18.7:81.3, or from 18.7:81.3 to 18.6:81.4, or from 18.6:81.4 to 18.5:81.5.

According to particular embodiments, the molar proportion of unit derived from trifluoroethylene relative to the unit derived from vinylidene fluoride is from 20.9:79.1 to 20.8:79.2, or from 20.8:79.2 to 20.7:79.3, or from 20.7:79.3 to 20.6:79.4, or from 20.6:79.4 to 20.5:79.5, or from 20.5:79.5 to 20.4:79.6, or from 20.4:79.6 to 20.3:79.7, or from 20.3:79.7 to 20.2:79.8, or from 20.2:79.8 to 20.1:79.9.

The polymer according to the invention has a molar fraction xₜ of third monomer(s), expressed in parts per million (ppm), of greater than or equal to 1 ppm and less than or equal to 5000 ppm. This molar fraction can especially be determined by elemental analysis of the element Z on the polymer. It is expressed relative to the total number of moles of units derived from VDF and TrFE in the polymer.

A sharp increase in the remanent polarization was observed from the first few ppm and/or about ten ppm of third monomer(s) in the polymer. Considering increasing amounts of third monomer, of the order of about a hundred ppm or a few thousand ppm, the remanent polarization continues to increase until it reaches a plateau before decreasing again.

Similarly, a decrease in the coercive field was observed from the first few ppm and/or about ten ppm of third monomer(s) in the polymer. Considering increasing amounts of third monomer, of the order of about a hundred ppm or a few thousand ppm, the coercive field continues to decrease until it reaches a plateau before increasing again.

The remanent polarization and the coercive field can be measured as in the examples.

In embodiments where the polymer comprises two or more third monomers, the fraction xₜ expresses the sum of the molar fractions of all the third monomers.

Preferably xₜ≥5 ppm, more preferably xₜ≥10 ppm, and even more preferably xₜ≥20 ppm.

For example, it may be that xₜ≥25 ppm, xₜ≥30 ppm, or xₜ≥40 ppm, or xₜ≥50 ppm, or xₜ≥60 ppm, or xₜ≥70 ppm, or xₜ≥80 ppm, or xₜ≥90 ppm, or xₜ≥100 ppm, or xₜ≥200 ppm, or xₜ≥400 ppm, or xₜ≥600 ppm, or xₜ≥800 ppm.

Preferably xₜ≤4000 ppm, more preferably xₜ≤3000 ppm, and even more preferably xₜ≤2500.

For example, it may be that xₜ≤2000 ppm, or xₜ≤1750 ppm or xₜ≤1500 ppm, or xₜ≤1400 ppm, or xₜ≤1300 ppm, or xₜ≤1200 ppm, or xₜ≤1100 ppm, or xₜ≤1000 ppm.

In light of the examples, it has been observed that with an increasing proportion of TrFE/(VDF+TrFE) in the polymer, the remanent polarization increases more rapidly from the first few ppm of third monomer in the structure of the polymer and/or the range xₜ where the remanent polarization remains at a substantially higher value than the remanent polarization of P(VDF-TrFE) having an equal VDF:TrFE ratio is more reduced.

According to particular embodiments, the polymer according to the invention has a molar proportion of unit derived from trifluoroethylene relative to the unit derived from vinylidene fluoride of 14.0:86.0 to 18.5:81.5 and 5 ppm≤xₜ≤5000 ppm.

Preferably, 10 ppm≤xₜ≤4500 ppm. It may be that 10 ppm≤xₜ≤25 ppm, or 25 ppm≤xₜ≤100 ppm, or 100 ppm≤xₜ≤200 ppm, or 200 ppm≤xₜ≤400 ppm, or 400 ppm≤xₜ≤600 ppm, or 600≤xₜ≤800 ppm, or 800 ppm≤xₜ≤1500 ppm, or 1500 ppm≤xₜ≤3000 ppm, or 3000 ppm≤xₜ≤4500 ppm. Over at least one of these intervals, the remanent polarization of the polymer is either of the same order as or greater than 1% or more, or 2.0% or more, or 3.0% or more or 4.0% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene.

According to certain embodiments, especially when the molar proportion of unit derived from trifluoroethylene relative to the sum of units derived from vinylidene fluoride and trifluoroethylene (TrFE/(VDF+TrFE)) in the polymer is less than 22.5%, or less than 22.0%, or less than 21.5%, or less than 21.0%, and/or
greater than 17.5% or greater than 18.0% or greater than 18.5% or greater than 19.0%,
especially when the molar proportion (TrFE/(VDF+TrFE)) is about 20.0%,
the remanent polarization, as measured in the examples, may advantageously have a value greater than or equal to 88 mC/m², or greater than or equal to 90 mC/m², or greater than or equal to 92 C/m² or greater than or equal to 94 mC/m² at 25 °C in an alternating electric field (sinusoidal signal of period 18 s) with a maximum amplitude equal to 150 V/μm. The coercive field may advantageously have a value of less than or equal to 50 V/μm, or less than or equal to 49 V/μm, or less than or equal to 48 V/μm.

According to particular embodiments, the polymer according to the invention has a molar proportion of unit derived from trifluoroethylene relative to the unit derived from vinylidene fluoride of 17.5:82.5 to 22.5:77.5 and 5 ppm≤xₜ≤5000 ppm. Preferably 10 ppm≤xₜ≤3000 ppm, and preferably 100 ppm≤xₜ≤2500 ppm. It may be that 100 ppm≤xₜ≤200 ppm, or 200 ppm≤xₜ≤1000 ppm, or 1000 ppm≤xₜ≤2000 ppm, or 2000 ppm≤xₜ≤2500 ppm.

It may be that 25 ppm≤xₜ≤100 ppm, or 100 ppm≤xₜ≤200 ppm, or 200 ppm≤xₜ≤400 ppm, or 400 ppm≤xₜ≤600 ppm, or 600≤xₜ≤800 ppm, or 800 ppm≤xₜ≤1000 ppm, or 1000 ppm≤xₜ≤2000 ppm, or 2000 ppm≤xₜ≤2500 ppm. Over at least one of these intervals, the remanent polarization of the polymer is either of the same order as or greater than 1% or more, or 2.0% or more, or 3.0% or more, or 4.0% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene. According to particular embodiments, the polymer according to the invention has a molar proportion of unit derived from trifluoroethylene relative to the unit derived from vinylidene fluoride of 19.0:81.0 to 21.0:79.0 and 5 ppm≤xₜ≤5000 ppm. Preferably 10 ppm≤xₜ≤3000 ppm, and preferably 100 ppm≤xₜ≤2500 ppm.

It may be that 25 ppm≤xₜ≤100 ppm, or 100 ppm≤xₜ≤200 ppm, or 200 ppm≤xₜ≤400 ppm, or 400 ppm≤xₜ≤600 ppm, or 600≤xₜ≤800 ppm, or 800 ppm≤xₜ≤1000 ppm, or 1000 ppm≤xₜ≤2000 ppm, or 2000 ppm≤xₜ≤2500 ppm. Over at least one of these intervals, the remanent polarization of the polymer is either of the same order as or greater than 1% or more, or 2.0% or more, or 3.0% or more, or 4.0% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene.

According to particular embodiments, the polymer according to the invention has a molar proportion of unit derived from trifluoroethylene relative to the unit derived from vinylidene fluoride of 20.1:79.9 to 20.9:79.1 and 5 ppm≤xₜ≤5000 ppm. Preferably 10 ppm≤xₜ≤3000 ppm, and preferably 100 ppm≤xₜ≤2500 ppm.

It may be that 25 ppm≤xₜ≤100 ppm, or 100 ppm≤xₜ≤200 ppm, or 200 ppm≤xₜ≤400 ppm, or 400 ppm≤xₜ≤600 ppm, or 600≤xₜ≤800 ppm, or 800 ppm≤xₜ≤1000 ppm, or 1000 ppm≤xₜ≤2000 ppm, or 2000 ppm≤xₜ≤2500 ppm. Over at least one of these intervals, the remanent polarization of the polymer is either of the same order as or greater than 1% or more, or 2.0% or more, or 3.0% or more, or 4.0% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene.

According to particular embodiments, the polymer according to the invention has a molar proportion of unit derived from trifluoroethylene relative to the unit derived from vinylidene fluoride of 22.5:77.5 to 27.5:72.5 and 5 ppm≤xₜ≤5000 ppm. Preferably 10 ppm≤xₜ≤2000 ppm, more preferably 50 ppm≤xₜ≤1500 ppm.

It may be that 25 ppm≤xₜ≤50 ppm, or 50 ppm≤xₜ≤100 ppm, or 200 ppm≤xₜ≤400 ppm, or 400 ppm≤xₜ≤600 ppm, or 600≤xₜ+≤800 ppm, or 800 ppm≤xₜ≤1200 ppm, or 1200 ppm≤xₜ≤1500 ppm. Over at least one of these intervals, the remanent polarization of the polymer is either of the same order as or greater than 1% or more, or 2.5% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene.

According to particular embodiments, the polymer according to the invention has a molar proportion of unit derived from trifluoroethylene relative to the unit derived from vinylidene fluoride of 23.5:76.5 to 26.5:73.5 and 5 ppm≤xₜ≤5000 ppm. Preferably 10 ppm≤xₜ≤2000 ppm, more preferably 50 ppm≤xₜ≤1500 ppm.

It may be that 25 ppm≤xₜ≤50 ppm, or 50 ppm≤xₜ≤100 ppm, or 200 ppm≤xₜ≤400 ppm, or 400 ppm≤xₜ≤600 ppm, or 600≤xₜ≤800 ppm, or 800 ppm≤xₜ≤1200 ppm, or 1200 ppm≤xₜ≤1500 ppm. Over at least one of these intervals, the remanent polarization of the polymer is either of the same order as or greater than 1% or more, or 2.0% or more, or 3.0% or more, or 4.0% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene.

According to particular embodiments, the polymer according to the invention has a molar proportion of unit derived from trifluoroethylene relative to the unit derived from vinylidene fluoride of 27.5:72.5 to 32.5:67.5 and 5 ppm≤xₜ≤5000 ppm. Preferably 10 ppm≤xₜ≤1200 ppm, and more preferably 25 ppm≤xₜ≤1000 ppm.

It may be that 25 ppm≤xₜ≤50 ppm, 50 ppm≤xₜ≤100 ppm, or 100 ppm≤xₜ≤200 ppm, or 200 ppm≤xₜ≤400 ppm, or 400≤xₜ≤600 ppm, or 600 ppm≤xₜ≤800 ppm, or 800 ppm≤xₜ≤1000 ppm. Over at least one of these intervals, the remanent polarization of the polymer is either of the same order as or greater than 1% or more, or 2.0% or more, or 3.0% or more, or 4.0% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene.

According to particular embodiments, the polymer according to the invention has a molar proportion of unit derived from trifluoroethylene relative to the unit derived from vinylidene fluoride of 28.5:71.5 to 31.5:68.5 and 5 ppm≤xₜ≤5000 ppm. Preferably 10 ppm≤xₜ≤1200 ppm, and more preferably 25 ppm≤xₜ≤1000 ppm.

It may be that 25 ppm≤xₜ≤50 ppm, 50 ppm≤xₜ≤100 ppm, or 100 ppm≤xₜ≤200 ppm, or 200 ppm≤xₜ≤400 ppm, or 400≤xₜ≤600 ppm, or 600 ppm≤xₜ≤800 ppm, or 800 ppm≤xₜ≤1000 ppm. Over at least one of these intervals, the remanent polarization of the polymer is either of the same order as or greater than 1% or more, or 2.0% or more, or 3.0% or more, or 4.0% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene.

According to particular embodiments, the polymer according to the invention has a molar proportion of unit derived from trifluoroethylene relative to the unit derived from vinylidene fluoride of 32.5:67.5 to 50.0:50.0 and 5 ppm≤xₜ≤5000 ppm. Preferably 10 ppm≤xₜ≤1000 ppm, and preferably 15 ppm≤xₜ≤500 ppm.

It may be that 15 ppm≤xₜ≤25 ppm, 25 ppm≤xₜ≤50 ppm, or 50 ppm≤xₜ≤100 ppm, or 100 ppm≤xₜ≤200 ppm, or 200≤xₜ≤300, or 300 ppm≤xₜ≤400 ppm, or 400 ppm≤xₜ≤500 ppm, or 500 ppm≤xₜ≤600 ppm. Over at least one of these intervals, the remanent polarization of the polymer is either of the same order as or greater than 1% or more, or 2.0% or more, or 3.0% or more, or 4.0% or more, or 5.0% or more, or 7.5% or more, or 10.0% or more, or 11.0% or more, or 12.0% or more, than the remanent polarization of P(VDF-TrFE) having an equal proportion of TrFE:VDF. Over at least one of these intervals, the coercive field is either of the same order as or less than 1.0% or more, or 2.0% or more, or 3.0% or more, or 4.0% or more, or 5.0% or more than the coercive field of P(VDF-TrFE) having an equal proportion of TrFE:VDF.

The third monomer may especially be chlorotrifluoroethylene.

### Manufacturing Process

The polymer may be obtained according to processes known from the prior art.

It may in particular be prepared by radical polymerization according to a solution, suspension, emulsion or microemulsion polymerization process of vinylidene fluoride and trifluoroethylene monomers and one or more third monomers.

Preferably, the polymer is prepared by a suspension polymerization process. Indeed, it is known to the skilled person that for a given proportion of units derived from vinylidene fluoride and trifluoroethylene, it is the suspension polymerization process which is generally capable of providing the polymer with the highest remanent polarization.

Advantageously, the polymer is prepared by a suspension polymerization process carried out in water.

The polymer may especially be used according to the process described in WO2016/055712, adapting the proportions of monomers according to the present invention. This process comprises successively:
injecting all the monomers to be reacted into a reactor;
initiating polymerization of the monomers;
a step (a) of continuing the polymerization of the monomers, during which a pressure drop in the reactor is compensated; in other words, the pressure in the reactor is kept at a substantially constant value; and
an optional step (b) during which the temperature is increased (without necessarily controlling the pressure).

Compensating the pressure drop during step (a) makes it possible to avoid the marked slowing of the reaction kinetics which is observed in the absence of such compensation, and which leads to a significant limitation on the degree of conversion, or to polymerization times which are incompatible with the industrial demands of productivity and capacity.

For compensating the pressure drop, it is possible to envisage using a variable-volume reactor, the volume of which is decreased (preferably continuously) during step (a).

Alternatively, and more simply, a stream is injected into the reactor during step (a), preferably continuously, so as to compensate the removal of the monomers being polymerized. The composition of the stream is chosen so as not to interfere with the polymerization reaction. It is thus possible to inject a stream of water into the reactor, or a stream of any other liquid which is immiscible with the monomers and inert with regard to the polymerization.

The pressure drop in the reactor is preferably totally compensated. Alternatively, it is partially compensated, in which case a certain reduction is still observed in the pressure in the reactor during step (a).

According to some embodiments, the pressure during step (a) can be kept substantially equal to a reference value of between 50 and 130 bar absolute, and preferably between 70 and 110 bar absolute.

According to some embodiments, the temperature inside the reactor during step (a) is less than or equal to 55 °C, and preferably less than or equal to 52 °C.

The increase in temperature during step (b) is advantageous in order to maximize the degree of conversion and the consumption of the monomers and also to reduce the residual amount of undecomposed initiator at the end of reaction (the residual presence of the initiator is unfavorable from the point of view of the purity and thermal stability characteristics of the product).

During step (b), it is possible either to continue to control the pressure or to stop doing so. In this case, during step (b), the pressure generally decreases in the reactor, with the polymerization continuing.

The reaction may be initiated by adding a radical polymerization initiator, which may especially be an organic peroxide such as a peroxydicarbonate. It is generally used in an amount of 0.1 to 10 g per kilogram of the total monomer charge. Preferably, the amount used may be from 0.5 to 5 g/kg.

The initiation of the reaction per se is generally carried out by the combined action of addition of the polymerization inhibitor and a rise in temperature, which is accompanied by a rise in pressure (the initiator may be added to the reactor after the monomers or before the monomers and before or after the rise in temperature).

Moreover, it may be advantageous to add a suspension agent to the reaction medium. Use may especially be made of a cellulose derivative, in particular a cellulose ether such as methylcellulose, ethylhydroxyethylcellulose, or hydroxypropylmethylcellulose, in an amount of 0.1 to 5 g per kilogram of the total monomer charge. Preferably, the amount used may be from 0.3 to 1.5 g/kg.

Finally, according to some embodiments, a chain length regulator may be added to the reaction medium. Use may especially be made of ethyl acetate or diethyl carbonate or an alcohol such as isopropanol, for example, in an amount of 5 to 100 g per kilogram of the total monomer charge. Preferably, the amount used may be from 10 to 40 g/kg.

Various processes for manufacturing trifluoroethylene are known.

Known especially is the production of trifluoroethylene by hydrogenolysis of chlorotrifluoroethylene. Such a process is for example described in patent applications EP 2 819 979 and EP 2 993 213. At the end of the process, a distillation step enables the recovery of pure trifluoroethylene or else of trifluoroethylene containing a small amount of chlorotrifluoroethylene, depending on the distillation conditions.

Trifluoroethylene is also known to be obtained by thermal decomposition of chlorodifluoromethane and chlorofluoromethane. Such a process is for example described in patent application EP 2 993 213.

In the embodiments where the third monomer is chlorotrifluoroethylene, the trifluoroethylene obtained by hydrogenolysis of chlorotrifluoroethylene, and used in the reaction for preparing the polymer according to the invention, may advantageously be purified so as to contribute to the supply of chlorotrifluoroethylene in the polymerization reaction.

The trifluoroethylene obtained by hydrogenolysis of chlorotrifluoroethylene may especially contribute to providing at least 25 mol %, or at least 50 mol %, or at least 60 mol %, or at least 70 mol %, or at least 75 mol %, or at least 80 mol %, or at least 85 mol %, or at least 90 mol %, or at least 95 mol %, or 100 mol % of chlorotrifluoroethylene relative to the total number of moles of chlorotrifluoroethylene necessary to carry out the polymerization reaction according to the invention.

The trifluoroethylene obtained by hydrogenolysis of chlorotrifluoroethylene may especially contain from 2 ppm to 5000 ppm, or from 5 ppm to 4000 ppm, or from 20 ppm to 3000 ppm, or from 50 ppm to 2500 ppm, or from 75 ppm to 1500 ppm of chlorotrifluoroethylene per mole of trifluoroethylene.

According to some embodiments, the trifluoroethylene obtained by hydrogenolysis of chlorotrifluoroethylene may contain from 2 ppm to 75 ppm, or from 75 ppm to 150 ppm, or from 150 ppm to 250 ppm, or from 250 ppm to 500 ppm, or from 500 ppm to 1000 ppm, or from 1000 ppm to 1500 ppm, or from 1500 ppm to 2000 ppm, or from 2000 ppm to 2500 ppm, or from 2500 ppm to 3000 ppm, or from 3000 ppm to 3500 ppm, or from 3500 ppm to 4000 ppm, or from 4000 ppm to 4500 ppm, or from 4500 ppm to 5000 ppm of chlorotrifluoroethylene per mole of trifluoroethylene.

According to some embodiments, the trifluoroethylene, especially the trifluoroethylene obtained by hydrogenolysis of chlorotrifluoroethylene, may have a purity of greater than or equal to 95.0%, preferentially greater than or equal to 98.0%, and extremely preferably greater than or equal to 99.0%. According to preferred embodiments, the trifluoroethylene may have a purity of greater than or equal to 99.5%. The trifluoroethylene may, for example, have a purity of greater than or equal to 99.6%, or greater than or equal to 99.7%, or greater than or equal to 99.8%, or greater than 99.9%.

Films can be prepared using the polymer according to the invention, for example by solvent casting or extrusion or hot melt compression.

For example, a polymer powder may be dissolved in methyl ethyl ketone. The solution can be poured onto a plate and then dried. The dried film may be annealed at a temperature below the melting temperature and above the Curie temperature of the polymer, to optimize its crystallinity.

These films may have a thickness of 1 μm to 50 μm, preferably of 2 μm to 25 μm, and extremely preferably of 5 μm to 15 μm.

According to some embodiments, films having an intermediate thickness of 15 to 25 μm can be prepared, and can then be stretched by a factor of 2 to 10, preferably of 5 to 7, to give a thickness of 1 μm to 5 μm.

Because of the higher remanent polarization of at least some of the polymers according to the invention relative to P(VDF-TrFE) of the same VDF:TrFE composition, films of lower thickness can be manufactured with equal performance. Conversely, for equal film thickness, the polymer films according to the invention have a better performance than the P(VDF-TrFE) films of the same VDF:TrFE composition.

Because of the lower coercive field of at least some of the polymers according to the invention relative to P(VDF-TrFE) of the same VDF:TrFE composition, films of a given thickness can be polarized at a lower electric field.

The polymers according to the invention can be used in the manufacture of electronic objects, especially sensors, actuators, memories, electrocaloric devices or any other application exploiting the ferroelectric properties of the material and especially a high value for remanent polarization.

The examples which follow disclose polymers according to the invention which have a higher remanent polarization and a lower coercive field relative to P(VDF-TrFE) having an equal VDF:TrFE proportion.

### EXAMPLES

In the experiments carried out below, a trifluoroethylene of high purity and containing no CTFE was used to implement comparative examples #1, #8 and #12. It is denoted below as trifluoroethylene of type “A”.

A trifluoroethylene, obtained by a chlorotrifluoroethylene hydrogenolysis process, containing 98 ppm of chlorotrifluoroethylene relative to the number of moles of trifluoroethylene, was used to implement examples #2, #3, #9 and #15. It is denoted below as trifluoroethylene of type “B”.

A trifluoroethylene, obtained by a chlorotrifluoroethylene hydrogenolysis process, containing 2010 ppm of chlorotrifluoroethylene relative to the number of moles of trifluoroethylene, was used to implement the other examples. It is denoted below as trifluoroethylene of type “C”.

The chlorofluoroethylene already present in the trifluoroethylene was taken into account for the calculation of the total chlorotrifluoroethylene introduced into the reaction medium. The total chlorofluoroethylene therefore corresponds to the sum of the masses of the chlorofluoroethylene present in a small amount in the trifluoroethylene and of the chlorofluoroethylene additionally introduced.

The weights of vinylidene fluoride and trifluoroethylene correspond to the effective weights introduced of each species.

### Example #1

Vinylidene fluoride (767 g) was reacted with trifluoroethylene of type A (253 g) in a 3.4 L reactor containing demineralized water (1670 g), methylhydroxypropylcellulose (0.60 g) and propyl peroxydicarbonate (1.53 g).

The reactor was then brought to a temperature of 50 °C and a pressure of 75 bar as quickly as possible in order to initiate the reaction. The start of the reaction results in a drop in reactor pressure, which was compensated by continuous injection of water (980 g). When all the water for compensating the pressure drop has been injected, the pressure dropped to 65 bar. The reactor was then heated to 65 °C, the pressure continuing to drop. When the pressure reached 38 bar, the reactor was cooled and then drained. The reaction mixture collected was filtered and the cake obtained was washed with water 5 times before being dried in an oven at 70 °C to constant weight.

### Example #8

Vinylidene fluoride (716 g) was reacted with trifluoroethylene of type A (305 g) in a 3.4 L reactor containing demineralized water (1730 g), methylhydroxypropylcellulose (0.60 g) and propyl peroxydicarbonate (1.6 g).

The reactor was then brought to a temperature of 50 °C and a pressure of 75 bar as quickly as possible in order to initiate the reaction. The start of the reaction results in a drop in reactor pressure, which was compensated by continuous injection of water (930 g). When all the water for compensating the pressure drop has been injected, the pressure dropped to 65 bar. The last steps are the same as for example #1.

### Example #12

Vinylidene fluoride (700 g) was reacted with trifluoroethylene of type A (386 g) in a 3.4 L reactor containing demineralized water (1680 g), methylhydroxypropylcellulose (0.60 g) and propyl peroxydicarbonate (1.7 g).

The reactor was then brought to a temperature of 50 °C and a pressure of 75 bar as quickly as possible in order to initiate the reaction. The start of the reaction results in a drop in reactor pressure, which was compensated by continuous injection of water (870 g). When all the water for compensating the pressure drop has been injected, the pressure dropped to 65 bar. The last steps are the same as for example #1.

### Example #2

Vinylidene fluoride (767 g) was reacted with trifluoroethylene (253 g; type B) in a 3.4 L reactor containing demineralized water (1670 g), methylhydroxypropylcellulose (0.60 g) and propyl peroxydicarbonate (1.53 g). The reaction medium also contains 0.035 g of CTFE introduced by the trifluoroethylene of type B.

The reactor was then brought to a temperature of 50 °C and a pressure of 75 bar as quickly as possible in order to initiate the reaction. The start of the reaction results in a drop in reactor pressure, which was compensated by continuous injection of water (980 g). When all the water for compensating the pressure drop has been injected, the pressure dropped to 65 bar. The reactor was then heated to 65 °C, the pressure continuing to drop. The last steps are the same as for example #1.

### Example #3

Vinylidene fluoride (767 g) was reacted with trifluoroethylene (253 g, type B) and chlorotrifluoroethylene (total amount of chlorotrifluoroethylene: 0.29 g, of which 0.035 g is introduced by the trifluoroethylene of type B) into a 3.4 L reactor containing demineralized water (1670 g), methylhydroxypropylcellulose (0.60 g) and propyl peroxydicarbonate (1.53 g).

The reactor was then brought to a temperature of 50 °C and a pressure of 75 bar as quickly as possible in order to initiate the reaction. The start of the reaction results in a drop in reactor pressure, which was compensated by continuous injection of water (980 g). When all the water for compensating the pressure drop has been injected, the pressure dropped to 65 bar. The last steps are the same as for example #1.

### Example #9

Vinylidene fluoride (712 g) was reacted with trifluoroethylene (310 g; type B) in a 3.4 L reactor containing demineralized water (1730 g), methylhydroxypropylcellulose (0.60 g) and propyl peroxydicarbonate (1.6 g). The reaction medium also contains 0.043 g of CTFE introduced by the trifluoroethylene of type B.

The reactor was then brought to a temperature of 50 °C and a pressure of 75 bar as quickly as possible in order to initiate the reaction. The start of the reaction results in a drop in reactor pressure, which was compensated by continuous injection of water (930 g). When all the water for compensating the pressure drop has been injected, the pressure dropped to 65 bar. The last steps are the same as for example #1.

### Example #15

Vinylidene fluoride (700 g) was reacted with trifluoroethylene (385 g, type B) and chlorotrifluoroethylene (total amount of chlorotrifluoroethylene: 0.47 g, of which 0.054 is supplied by the trifluoroethylene of type B) in a 3.4 L reactor containing demineralized water (1680 g), methylhydroxypropylcellulose (0.60 g) and propyl peroxydicarbonate (1.7 g).

The reactor was then brought to a temperature of 50 °C and a pressure of 75 bar as quickly as possible in order to initiate the reaction. The start of the reaction results in a drop in reactor pressure, which was compensated by continuous injection of water (870 g). When all the water for compensating the pressure drop has been injected, the pressure dropped to 65 bar. The last steps are the same as for example #1.

### Example #5

Vinylidene fluoride (767 g) was reacted with trifluoroethylene (253 g; type C) in a 3.4 L reactor containing demineralized water (1670 g), methylhydroxypropylcellulose (0.60 g) and propyl peroxydicarbonate (1.53 g). The reaction medium also contains 0.72 g of CTFE introduced by the trifluoroethylene of type C.

The reactor was then brought to a temperature of 50 °C and a pressure of 75 bar as quickly as possible in order to initiate the reaction. The start of the reaction results in a drop in reactor pressure, which was compensated by continuous injection of water (980 g). When all the water for compensating the pressure drop has been injected, the pressure dropped to 65 bar. The reactor was then heated to 65 °C, the pressure continuing to drop. The last steps are the same as for example #1.

### Example #4

Vinylidene fluoride (767 g) was reacted with trifluoroethylene (253 g, type C) and chlorotrifluoroethylene (total amount of chlorotrifluoroethylene: 0.86 g, of which 0.72 g of CTFE is supplied by the trifluoroethylene of type C) in a 3.4 L reactor containing demineralized water (1670 g), methylhydroxypropylcellulose (0.60 g) and propyl peroxydicarbonate (1.53 g).

The reactor was then brought to a temperature of 50 °C and a pressure of 75 bar as quickly as possible in order to initiate the reaction. The start of the reaction results in a drop in reactor pressure, which was compensated by continuous injection of water (980 g). When all the water for compensating the pressure drop has been injected, the pressure dropped to 65 bar. The reactor was then heated to 65 °C, the pressure continuing to drop. The last steps are the same as for example #1.

### Example #6

Vinylidene fluoride (767 g) was reacted with trifluoroethylene (253 g, type C) and chlorotrifluoroethylene (total amount of chlorotrifluoroethylene: 1.61 g, of which 0.72 g of CTFE is supplied by the trifluoroethylene of type C) in a 3.4 L reactor containing demineralized water (1670 g), methylhydroxypropylcellulose (0.60 g) and propyl peroxydicarbonate (1.53 g).

The reactor was then brought to a temperature of 50 °C and a pressure of 75 bar as quickly as possible in order to initiate the reaction. The start of the reaction results in a drop in reactor pressure, which was compensated by continuous injection of water (980 g). When all the water for compensating the pressure drop has been injected, the pressure dropped to 65 bar. The reactor was then heated to 65 °C, the pressure continuing to drop. The last steps are the same as for example #1.

### Example #7

Vinylidene fluoride (765 g) was reacted with trifluoroethylene (256 g, type C) and chlorotrifluoroethylene (total amount of chlorotrifluoroethylene: 0.80 g, of which 0.73 g is supplied by the trifluoroethylene of type C) in a 3.4 L reactor containing demineralized water (1670 g), methylhydroxypropylcellulose (0.60 g) and propyl peroxydicarbonate (1.53 g).

The reactor was then brought to a temperature of 50 °C and a pressure of 75 bar as quickly as possible in order to initiate the reaction. The start of the reaction results in a drop in reactor pressure, which was compensated by continuous injection of water (980 g). When all the water for compensating the pressure drop has been injected, the pressure dropped to 65 bar. The reactor was then heated to 65 °C, the pressure continuing to drop. The last steps are the same as for example #1.

### Example #10

Vinylidene fluoride (714 g) was reacted with trifluoroethylene (306 g; type C) in a 3.4 L reactor containing demineralized water (1730 g), methylhydroxypropylcellulose (0.60 g) and propyl peroxydicarbonate (1.60 g). The reaction medium also contains 0.87 g of CTFE introduced by the trifluoroethylene of type C.

The reactor was then brought to a temperature of 50 °C and a pressure of 75 bar as quickly as possible in order to initiate the reaction. The start of the reaction results in a drop in reactor pressure, which was compensated by continuous injection of water (930 g). When all the water for compensating the pressure drop has been injected, the pressure dropped to 65 bar. The reactor was then heated to 65 °C, the pressure continuing to drop. The last steps are the same as for example #1.

### Example #11

Vinylidene fluoride (714 g) was reacted with trifluoroethylene (306 g, type C) and chlorotrifluoroethylene (total amount of chlorotrifluoroethylene: 0.92 g, of which 0.87 g is supplied by the trifluoroethylene of type C) into a 3.4 L reactor containing demineralized water (1730 g), methylhydroxypropylcellulose (0.60 g) and propyl peroxydicarbonate (1.6 g).

The reactor was then brought to a temperature of 50 °C and a pressure of 75 bar as quickly as possible in order to initiate the reaction. The start of the reaction results in a drop in reactor pressure, which was compensated by continuous injection of water (930 g). When all the water for compensating the pressure drop has been injected, the pressure dropped to 65 bar. The reactor was then heated to 65 °C, the pressure continuing to drop. The last steps are the same as for example #1.

### Example #13

Vinylidene fluoride (703 g) was reacted with trifluoroethylene (385 g, type C) and chlorotrifluoroethylene (total amount of chlorotrifluoroethylene: 1.49 g, of which 1.10 g is supplied by the trifluoroethylene of type C) in a 3.4 L reactor containing demineralized water (1680 g), methylhydroxypropylcellulose (0.60 g) and propyl peroxydicarbonate (1.7 g).

The reactor was then brought to a temperature of 50 °C and a pressure of 75 bar as quickly as possible in order to initiate the reaction. The start of the reaction results in a drop in reactor pressure, which was compensated by continuous injection of water (870 g). When all the water for compensating the pressure drop has been injected, the pressure dropped to 65 bar. The reactor was then heated to 65 °C, the pressure continuing to drop. The last steps are the same as for example #1.

### Example #14

Vinylidene fluoride (703 g) was reacted with trifluoroethylene (385 g, type C) and chlorotrifluoroethylene (total amount of chlorotrifluoroethylene: 40.15 g, of which 1.10 g is supplied by the trifluoroethylene of type C) in a 3.4 L reactor containing demineralized water (1680 g), methylhydroxypropylcellulose (0.60 g) and propyl peroxydicarbonate (1.7 g).

The reactor was then brought to a temperature of 50 °C and a pressure of 75 bar as quickly as possible in order to initiate the reaction. The start of the reaction results in a drop in reactor pressure, which was compensated by continuous injection of water (870 g). When all the water for compensating the pressure drop has been injected, the pressure dropped to 65 bar. The reactor was then heated to 65 °C, the pressure continuing to drop. The last steps are the same as for example #1.

### Characterization of the Polymers

### Determination of the Molar Proportion TrFE/(VDF+TrFE) in the Polymer

The molar proportion TrFE/(VDF+TrFE) in the polymer, denoted x_{TrFE}, was determined by proton NMR. The polymer was dissolved in a suitable deuterated solvent and the NMR spectrum was recorded on an FT-NMR spectrometer fitted with a multinuclear probe. The hydrogen nucleus of the TrFE unit (CHF═CF₂) gives a distinctive signal at about 5 ppm, whereas the 2 hydrogen atoms of the CH₂ group of the VDF units give a broad unresolved peak centered at 3 ppm.

The relative integration of both signals gives the relative abundance of both monomers, that is to say their molar ratio.

### Determination of the Molar Proportion CTFE/(VDF+TrFE) in the Polymer

The molar proportion CTFE/(VDF+TrFE) in the polymer, denoted xₜ, can be determined by measuring the chlorine content by elemental analysis.

Because of the reactivity of CTFE relative to VDF and TrFE, and the amounts introduced into the reaction medium, it can also be considered that the whole of the CTFE introduced into the reaction medium is also introduced into the structure of the polymer.

### Determination of the Remanent Polarization and the Coercive Field

Polymer films were prepared from a 14% by weight solution in methyl ethyl ketone filtered to 0.2 μm. The solution was coated onto a glass plate and allowed to dry for 12 hours. The films were detached from the surface and placed in an oven under vacuum at 80 °C for 4 hours for evaporation of the solvent. The films were thereafter placed in an oven for 1 hour 5 at 15 °C below the melting temperature of the polymer as measured by differential scanning calorimetry.

The ferroelectric characteristics of the material, in particular its remanent polarization and its coercive field, were measured at 25 °C in an alternating electric field (sinusoidal signal of period 18 s) with a maximum amplitude equal to 150 V/μm.

The remanent polarization, Pr, is defined as the value of the polarization measured at zero field. The coercive field (Ec) is defined as the value of the applied field for which the measured polarization is zero.

Table 1 lists all of the characterization measurements for the films of composition #1-#15:

TABLE 1

| | x_{TrFE} | xₜ | E_{C} | Pᵣ |
|---|---|---|---|---|
| Examples | (mol %) | (ppm) | (V/μm) | (mC/m²) |
| #1 | 20.4 | 0 | 50 | 85 |
| #2 | 20.4 | 20 | 50 | 88 |
| #3 | 20.4 | 170 | 46 | 93 |
| #4 | 20.4 | 490 | 46 | 94 |
| #5 | 20.4 | 410 | 46 | 95 |
| #6 | 20.5 | 920 | 45 | 95 |
| #7 | 20.7 | 490 | 48 | 93 |
| #8 | 25.1 | 0 | 50 | 69 |
| #9 | 25.3 | 25 | 46 | 73 |
| #10 | 25.2 | 507 | 48 | 75 |
| #11 | 25.1 | 530 | 48 | 75 |
| #12 | 29.7 | 0 | 50 | 64 |
| #13 | 30.0 | 816 | 49 | 67 |
| #14 | 28.8 | 22000 | 51.96 | 56.3 |
| #15 | 30.0 | 276 | 41.25 | 70.9 |

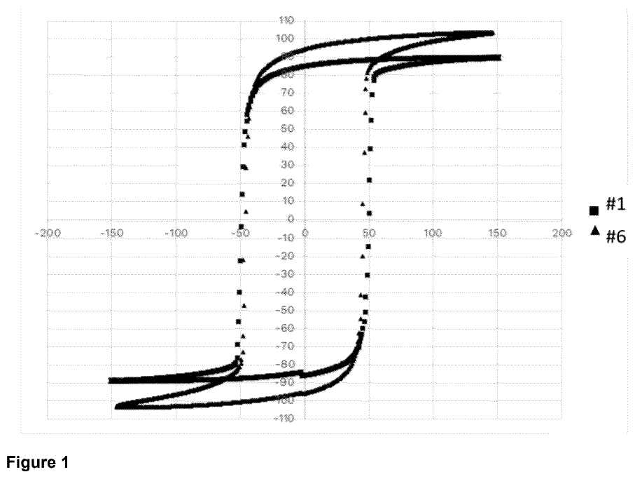

FIG. 1 corresponds to the curves of polarization as a function of the electric field for a film prepared with the polymer according to comparative example #1 (“▪”) and according to example #6 (“▴”). It can be seen that the hysteresis curve for the polymer according to the invention is narrower (lower E_{c}) and higher (higher Pᵣ) than for the comparative polymer.

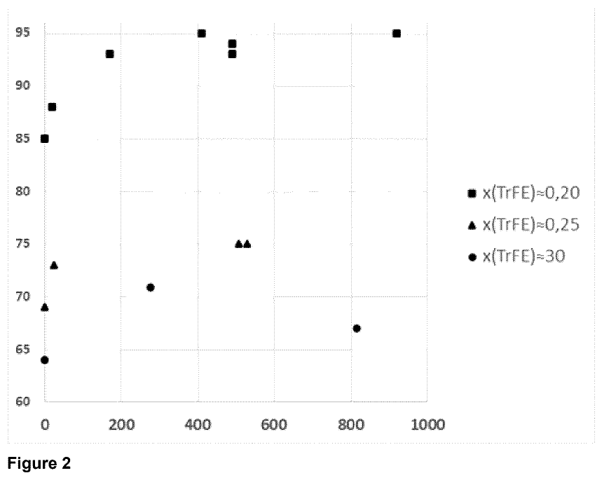

FIG. 2 shows the remanent polarization of the films of composition #1-#13 and #15 as a function of the proportion of CTFE in the polymer.

In light of Table 1 and FIG. 2, at least the following points can be noted:
The remanent polarization increases in the polymer for increasing x_{TrFE}, which was known to the skilled person (compare for example Pr in comparative examples #1, #8, #12).
Excessive addition of CTFE in the structure of a P(VDF-TrFE) transforms the polymer with ferroelectric properties into a relaxor ferroelectric, which was known to the skilled person (see the very low Pr of comparative example #14 relative to that of comparative example #12).
The remanent polarization of the polymer having a given TrFE:VDF proportion increases rapidly from the first few ppm or about ten ppm of CTFE in the polymer (see for example Pr of example #2 by comparison with Pr of comparative example #1, or else Pr of example #9 by comparison with Pr of comparative example #8).
The remanent polarization of the polymer having a given TrFE:VDF proportion remains high, especially above the remanent polarization of the corresponding P(VDF-TrFE) for xₜ of the order of 1000 ppm and more.
Examples #2-#7, #9-#11 and #13-#15 have a higher remanent polarization and a lower coercive field than the remanent polarization and coercive field values of the corresponding P(VDF-TrFE) (comparative examples #1, #8 and #12, respectively).

1. A polymer consisting essentially of repeating units derived from vinylidene fluoride (VDF), trifluoroethylene (TrFE) and at least one third monomer other than vinylidene fluoride and trifluoroethylene, having the chemical formula:
CX₁X₂═CX₃Z (I)
in which each of X₁, X₂ and X₃ is independently chosen from H, F and alkyl groups comprising from 1 to 3 carbon atoms which are optionally partially or totally fluorinated, and in which Z is chosen from Cl, Br and I,
the molar ratio TrFE:VDF between the number of moles of unit derived from trifluoroethylene and that of unit derived from vinylidene fluoride in the polymer being from 14.0:86.0 to 50.0:50.0,
said repeating unit derived from said at least one third monomer having a molar fraction xₜ of greater than or equal to 1 ppm and less than or equal to 5000 ppm, relative to the total number of moles of units derived from VDF and TrFE in the polymer.

2. The polymer of claim 1, wherein said at least one third monomer comprises at least one monomer selected from the group consisting of: chlorotrifluoroethylene (CTFE), chlorodifluoroethylene, chlorofluoroethylene, and a mixture thereof.

3. The polymer of claim 2, comprising a single third monomer selected from the group consisting of: chlorotrifluoroethylene (CTFE), chlorodifluoroethylene (CDFE), and chlorofluoroethylene.

4. The polymer of claim 1, wherein said at least one third monomer is chlorotrifluoroethylene (CTFE).

5. The polymer of claim 1, wherein xₜ≥5 ppm.

6. The polymer of claim 1, wherein xₜ≥400 ppm.

7. The polymer of claim 1, wherein xₜ≥600 ppm.

8. The polymer of claim 1, wherein xₜ≤4000 ppm.

9. The polymer of claim 1, wherein xₜ≤1000 ppm.

10. The polymer of claim 1, wherein the TrFE:VDF molar ratio in the polymer is from 15.0:85.0 to 40.0:60.0.

11. The polymer of claim 1, having a melt index at 230 °C under a load of 10 kg, as measured according to the standard ASTM D1238-10, of 0.1 g/10 min to 100 g/10 min.

12. The polymer of claim 1, wherein the TrFE:VDF molar ratio in the polymer is from 17.5:82.5 to 22.5:77.5.

13. The polymer of claim 1, wherein the TrFE:VDF molar ratio in the polymer is from 20.1:79.9 to 20.9:79.1.

14. The polymer of claim 1, obtained by a suspension polymerization process.

15. A film comprising essentially the polymer of claim 1.

16. A method comprising using a third monomer having the chemical formula:
CX₁X₂═CX₃Z (I)
in which each of X₁, X₂ and X₃ is independently chosen from H, F and alkyl groups comprising from 1 to 3 carbon atoms which are optionally partially or totally fluorinated, and in which Z is chosen from Cl, Br and I,
as a termonomer in the structure of a polymer consisting essentially of repeating units derived from vinylidene fluoride (VDF) and trifluoroethylene (TrFE) in a molar proportion xₜ of 1 ppm to 5000 ppm with respect to the total number of moles of units derived from VDF and TrFE in the polymer,
the molar ratio TrFE:VDF in the polymer between the unit derived from TrFE and that derived from VDF being from 14.0:86.0 to 50.0:50.0,
to increase the remanent polarization thereof.

17. A method comprising using a third monomer having the chemical formula:
CX₁X₂═CX₃Z (I)
in which each of X₁, X₂ and X₃ is independently chosen from H, F and alkyl groups comprising from 1 to 3 carbon atoms which are optionally partially or totally fluorinated, and in which Z is chosen from Cl, Br and I,
as a termonomer in the structure of a polymer consisting essentially of repeating units derived from vinylidene fluoride (VDF) and trifluoroethylene (TrFE) in a molar proportion xₜ of 1 ppm to 5000 ppm with respect to the total number of moles of units derived from VDF and TrFE in the polymer,
the molar ratio TrFE:VDF in the polymer between the unit derived from TrFE and that derived from VDF being from 14.0:86.0 to 50.0:50.0, to reduce the coercive field thereof.

18. The method of claim 16, wherein the third monomer is selected from the group consisting of: chlorotrifluoroethylene (CTFE), chlorodifluoroethylene (CDFE).

19. The method of claim 16, wherein the third monomer is chlorotrifluoroethylene.

20. The method of claim 16, wherein xₜ≥25 ppm.

21. The method of claim 16, wherein xₜ≤2500 ppm.

22. The method of claim 16, wherein xₜ≤800 ppm.

23. A method comprising using trifluoroethylene obtained by hydrogenolysis of chlorotrifluoroethylene in a process for manufacturing a polymer of claim 1, wherein said at least one third monomer comprises chlorotrifluoroethylene, said manufacturing process comprising a polymerization reaction step between vinylidene fluoride (VDF), trifluoroethylene (TrFE) and chlorotrifluoroethylene (CTFE).

24. The method of claim 23, wherein the trifluoroethylene obtained by hydrogenolysis of chlorotrifluoroethylene comprises from 2 ppm to 5000 ppm of chlorotrifluoroethylene per mole of trifluoroethylene.

25. The method of claim 24, wherein the trifluoroethylene obtained by hydrogenolysis of chlorotrifluoroethylene comprises from 1500 ppm to 4500 ppm of chlorotrifluoroethylene per mole of trifluoroethylene.
